(19) United States
(12) Patent Application Publication
(10) Pub. No.: US 2011/0020524 A1
(43) Pub. Date: Jan. 27, 2011

(54) Tofu coagulant and process for producing the same

(75) Inventors: Toichiro Takai, Ishikawa-gun (JP); Toru Awazu, Ishikawa-gun (JP); Motonari Amano, Ishikawa-gun (JP); Masahiro Yoshida, Ishikawa-gun (JP); Masaaki Watanabe, Ishikawa-gun (JP)

Correspondence Address: KANESAKA BERNER AND PARTNERS LLP, 1700 DIAGONAL RD, SUITE 310, ALEXANDRIA, VA, 22314-2848, US

(73) Assignee: TAKAI TOFU & SOYMILK EQUIPMENT CO., Ishikawa-gun (JP)

(21) Appl. No.: 12/805,349

(22) Filed: Jul. 27, 2010

(30) Foreign Application Priority Data
Jul. 27, 2009 (JP) 2009-174835

(51) Int. Cl. A23D 7/00

(52) U.S. Cl. 426/602

(57) ABSTRACT

A method for producing tofu coagulant includes a mineral salt solution as water phase (tank T2) and a food fat as oil phase including a diacylglycerol is 1 wt % or more (tank T1), comprising: a stirring and mixing step of the water phase and the oil phase to W/O type emulsion by emulsifying dispersion machine M1.

### TECHNICAL FIELD

The present invention relates to a tofu coagulant without emulsifier and a process for producing the same.

### BACKGROUND ART

A mineral salt such a magnesium chloride (called “Nigari” in Japan) and a calcium chloride which working as tofu coagulant and used for producing tofu. And a glucono-δ-lactone that coagulating component is gluconic acid working as tofu coagulant and used for producing Tofu. It is skilful making a high quality tofu such a fine texture, a good touch with teeth and tongue, and a good taste. Particularly magnesium chloride and gluconic acid are very fast reaction rate with soymilk, and difficult to produce the high quality tofu constantly, shows in patent document 4 (JP 3553690B1). Thus, fat and emulsifier are mixed in magnesium chloride solution for making emulsification phase as water in oil (W/O) type, and which coagulant emulsion is commercially available, for example. And, a tofu coagulant which is comprised magnesium chloride, polyglycerol esters of fatty acids as emulsifier, and diglyceride, is disclosed in patent document 2 (JP 2908633B1). Diglyceride (DG) and Diacylglycerol (DAG) are same. And, a tofu coagulant which is comprising mineral salt coagulant, polyglycerol esters of fatty acids, and fat, is disclosed in patent document 3 (JP 2912249B1).

As above commercial emulsifier tofu coagulant comprises Nigari, it having a good slow-acting character and which is used manufacturing tofu products at high temperature solidification and popularized. The commercial emulsifier tofu coagulant is used preferable for mass production scale at tofu factory, because it induce stable product quality, low loss, and high working-efficiency. However, some consumers feel a peculiar flavor that is different to original tofu flavor, and increasing a uniform flavor of tofu products, losing distinctive regional production, same character by different manufacturers. Moreover, the commercial emulsifier tofu coagulant is 5 or 6 times more expensive than normal Nigari. The occasion of the recent economic downturn, rising fuel cost and soybeans cost and, wholesale price down pressure has been forced, in addition have to use expensive tofu coagulant, thus tofu manufacturer's economic burden that more and more. For reducing tofu costs, so tofu manufacturer yearn doesn't use the expensive tofu coagulant as possible and to provide consistent high-quality tofu production. Further more, the commercial emulsifier tofu coagulant including synthetic emulsifiers and stabilizers, thus it having a good slow-acting character, but, it is necessary to use with high-power emulsifying dispersion machine for good dispersion. Therefore, sometimes dispersion level of the commercial emulsifier tofu coagulant is low and tofu products lost or amount of the commercial emulsifier tofu coagulant is much and tofu product deteriorated during distribution process. In recent years, the global boom in Japanese food, tofu is a situation where demand is growing by the principle natural food, especially vegetarian. Especially in the West has increased the demand for organic products, processed food in Japan is about 60% organic soy milk and tofu products that situation would. Future, tofu products, consisting of natural raw materials are expected to continue to increase as the representative of the expected natural food without any synthetic chemical food additives.

The applicant herein issued and patent granted tofu manufacturing method patent document 1 (JP 3654623B1) which is given in the device configuration and do not use emulsifiers as additives. However, to enforce a narrow scope, selected by a combination of food fat and Nigari what kind of concentration and type, was not consistently high-quality tofu satisfy. For reducing the cost of W/O type emulsified coagulant emulsion, use less oil, and reduce the amount of aqueous phase, it is necessary to use higher concentrations of aqueous Nigari, for example. However, high concentrations Nigari, it can stabilize the product by increases the viscosity of the emulsion, but it is difficult to make optimal stable emulsified phase affected by heat such a friction heat, thus practical slow-acting character was hard to obtain.

Study to W/O type emulsion characteristic that is used salt water and processing oil and does not use emulsifiers as additive, is disclosed in prior art document 2 and prior art document 5. The processing oil comprises DAG more than 80%. But, those prior art 2, 3 were not evaluated slow-acting character as tofu coagulant, and concentration of magnesium chloride solution is 0.5M or less, and it is not affected by heat such a friction heat. And it is evaluated that salt water phase and oil phase ratio is 1:1 only. Unit M is the molar concentration per liter of solution. Concentration of magnesium chloride solution that converted to magnesium chloride based on 06 water salt crystals of molecular weights approximately 203 is about 10% w/v, and the specific gravity is approximately 1.036. Nigari concentration in less than 2 M, and inconvenient solution emulsified with fever and increased emulsion viscosity is less obvious. If using coagulation of soy milk to dilute salt solution, the aqueous phase increases and it is necessary to increase the amount of fat, thus does not be economical. DAG is a fat which is same as conventional triacylglycerol (TAG). DAG is a fat component that is comprised a number of commercial vegetable oils such as olive oil, and DAG is the percent of ingredients that contain fat, is disclosed in prior art document 6.

Patent Document

Patent document 1 is JP 3654623B1
Patent document 2 is JP 2908633B1
Patent document 3 is JP 2912249B1
Patent document 4 is JP 3553690B1
Patent document 5 is JP 3853778B1

Literature

Document 1 is A. Tsuji, Solubilization and emulsification technique, Engineering Library co., ltd, page 58-114.
Document 2 is A. Shimada and K. Ohashi, Effect of salt type on the emulsifying Properties of water-in-oil emulsions prepared with diacyglycerol without an emulsifier, School of Human Life Sciences Showa Women's University, vol. 14, page 31-38, 2005 year.
Document 3 is A. Shimada and K. Ohashi, Interfacial and emulsifying properties of diacyglycerol, Food science technology research, No. 9, page 142-147, 2003 year.
Document 4 is M. Kimura, et al., Emulsifying properties of various vegetable oils, Bioscience, Biotechnology, and Biochemistry (Japan Society for Bioscience, Biotechnology, and Agrochemistry) Z53-G223., vol. 58, page 1258-1261, 1994 year.
Document 5 is K. Sugita, et al., Encyclopedia of Japan foods, Ishiyaku Publishers, Inc., page 527-544, 1^{st} establishment 25 Feb. 2003 year. Document 6: Riv.Ital.Grasse, La Rivista italiana delle sostanze grasse, Vol. 69, page 443-447, 1992 year.

### DISCLOSURE OF THE INVENTION

### Problems the Invention Intends to Solve

As above patent document 1, a milk solid (emulsion) is obtained which basis liquid oil such a soybean oil and thin magnesium chloride solution used by emulsion circulation means. And concentration of the magnesium chloride solution is about 1.8 M that converted to magnesium chloride based on 06 water salt is about 33% w/w, and the specific gravity is approximately 1.1. However, the milk solid will return to the original phase at few seconds, thus it is necessary uses the emulsion circulation means continuously during to use. So, the milk solid is easy to breakdown the emulsion cause of increasing viscosity and heating. Therefore, the milk solid is difficult to handle. The feed pump stator and rotor fitted as likely Mono-pump is caused re-aggregate the emulsification for their rubbing action. Moreover, in case of W/O ratio 1:1 that concentration of the magnesium chloride solution is 17% w/w and additive ratio for soymilk is 1.7 to 1.8 wt %, and in case of W/O ratio 2:1 that concentration of the magnesium chloride solution is 22% w/w and additive ratio for soymilk is 1.3 to 1.4 wt %. There is no emulsifier and use more oil, so the milk solid additive amount is much more in actual. Then, it is necessary to use large feed pump and tank, and material cost is increase by using food oil. Unless otherwise specified, “%” all “weight percent” is.

As above patent document 2 and 3, polyglycerol esters of fatty acids as emulsifier is slow-acting and flavor is getting worse when it amount is much. The polyglycerol esters of fatty acids is strong emulsifier and become uneven soymilk when strong circulation means unused. And in case of it happens that white speck remains in tofu, the speck stick on package film, and cloth does not easy to remove momen-tofu. Therefore, it is necessary to use a high-speed mixer and the mixer is over loaded working continuously.

The applicant herein issued and patent granted tofu manufacturing method as above patent document 1 (JP 3654623B1) which is, to enforce a narrow scope and the tofu coagulant is unstable that without keeping a emulsified phase by machine and easy to occur dividing oil phase and water phase, so that is not getting slow-acting effect enough, thus it was difficult to manufacturing high-quality tofu constantly. After that, the applicant herein studied and found much better manufacturing conditions for a tofu coagulant which is not used expensive commercial emulsifier. That is to say, the tofu coagulant is obtained that is selected a high concentration solution for rapid onset of action and a fat which appropriate DAG oil composition of the predetermined conditions are satisfied and content and selected a specified emulsification condition.

The object of the present invention is, therefore, to provide a tofu coagulant without expensive commercial emulsifier and a process for producing the same. The tofu coagulant is comprises a solution for rapid onset of action and a food fat in general oil expeller process, and the tofu coagulant is good keeping a W/O type emulsified phase. Moreover, uses the present invention tofu coagulant is for reducing the economic burden, and facilitate the creation of the original flavor, can enhance the image of the original organic food tofu, tofu contribute to building a high-quality, safe and secure and stable.

### SUMMARY OF THE INVENTION

To accomplish the above object, the present invention provides a tofu coagulant comprising: a mineral salt solution as water phase; a food fat as oil phase including a diacylglycerol is 1 wt % or more, and wherein the water phase and the oil phase are stirred and mixed to W/O type emulsion. According to the tofu coagulant, wherein the concentration of mineral salt solution is 2 M or more, is preferably. According to the tofu coagulant, wherein the mineral salt solution comprising at least any one of a magnesium chloride, calcium chloride, sodium chloride, potassium chloride, magnesium sulfate, magnesium chloride seawater crude, is preferably.

According to the present invention, in particular to use the dense mineral salt solution that concentration is 2 M or more, then decreasing amount of expensive fat, therefore the tofu coagulant cost is economically. The dense mineral salt solution 2 M or more is effective slow-acting that delay to coagulate reaction of soymilk, and the dense mineral salt solution closer to water saturated solution, more effective slow-acting. To use the dense mineral salt solution, viscosity of the mineral salt solution is increased during the emulsification. When the emulsified tofu coagulant is high viscosity, fine dispersed particles as particles phase are prevented to re-aggregate, thus easy to keep the fine dispersed particles. The finer dispersed particles, is get better slow-acting after added in soymilk and stirred. On the other hand, the higher viscosity of mineral salt solution is heated up easy such a friction heat (stirring heat) during emulsion dispersion with fat. Therefore, at least one of the water phase or the oil phase is cooled by cooling means during the stirring and mixing step, is preferably. The water phase and the oil phase is cooled by cooling means during the stirring and mixing step, is more preferably. When emulsion dispersion is doing without cooling continuously, the emulsion is more heated up and doing to re-aggregate and unstable emulsified phase, thus slow-acting effect is worse, sometimes. When target cooling temperature is room temperature or higher, air cooling means is acceptable to use. When target cooling temperature is below room temperature, indirect cooling means such as water chillers and water cooled refrigerant is better. It is necessary to partial or most of the heat endotherm at least the stirring and mixing.

W/O type emulsion is obtained easy by Diacylglycerol (DAG), is disclosed in prior art document 2. A fat comprises DAG about 87% and high concentration in document 2. Moreover, melting point of DAG is between 20 and 70 degC and higher without linoleic acid, linolenic acid, is disclosed in oleochemical handbook third revised edition from page 148-149. Thus, the fat is solidified at room temperature, but the point is not issued in document 2. If a tofu coagulant that Nigari is dispersed in a solidified fat added into soymilk as shown in document 2, it is effective slow-acting but it is difficult to control by machine.

According to the present invention, when the fat is solidified, pre-warmed over the melting point and liquid fat is stirred and mixed. And when the fat is solidified by cooling after emulsified, pre-warmed over the melting point and liquid the emulsified tofu coagulant is used before addition to soymilk. When use a fat easy to solidify, attaches a keeping heat means on pipes, tanks, and valves, preferably.

For example, olive oil, rice bran oil or rice oil, cottonseed oil such as commercially available natural oils comprises DAG between 5 and 10%, and those natural oils are estimated comprises highly melting point of DAG cause of their fatty acid composition. But, regarding to the present invention, uses DAG smaller than prior art, thus, it is no problem to handle by machine.

The present invention of tofu coagulant has more hydrophilicity than soybean oil comprises DAG between 1 and 2%, i.e. the tofu coagulant is low interfacial tension. According to the present invention of tofu coagulant, comprises a concentrated magnesium chloride solution as a dispersed phase and a liquid fat as a continuous phase, thus, the water phase and the oil phase are stirred and mixed to W/O type emulsion and stable W/O type emulsion is formed, we found it. The above things, other than any of constituents, first revealed that DAG effect quality.

The present invention of tofu coagulant, wherein the food fat comprises DAG 1% or more. DAG shows a form of two molecules of fatty acid and ester-linked glycerol molecule. Any emulsifier is not comprised in the invention tofu coagulant.

The present invention of tofu coagulant, the food fat is added food additives as processing aid in the general fat manufacturing process that is no problem, and the food fat is added chemical processing such a transesterification and curing process of hydrogenation that is no problem. The food fat is obtained in the general oil expeller process that is not processed any special processing, preferably. That is to say, the food fat comprises Monoacylglycerol (MAG) 1% or less and the food fat is not contains lecithin (phospholipid) such as emulsification, preferably. The food fat comprises DAG is 1% or more and DAG is less than 10%, that is economical condition and suitable for this invention. The food fat such a processing oil comprises DAG is 10% or more, is more suitable for this invention, but, it is not easy to handle because it is solidified at room temperature and material cost is increased, thus the composition of the food fat is chosen by the cost-effectiveness.

The present invention of tofu coagulant, the food fat is not limited. For example, Rice oil, rice-bran oil, rice-germ oil, Corn oil, Soybean oil, Rapeseed oil, Canola-seed oil, Sunflower oil, Safflower oil, High-oleic-safflower oil, Sesame oil, Palm oil, Palm-kernel oil, Olive oil, Virgin-olive oil, Pure-olive oil), Grape-seed oil, Hazelnut oil, Palm oil (Coconut oil), Cottonseed oil, Peanut oil, Macadamia-nut oil, Almond oil, Avocado oil, Linseed oil, Pumpkinseed oil, Walnut oil, Sesame oil, Cashewnut oil, Wheat-germ oil, Borasseed oil, Evening-primrose oil, Borage oil, Black-currantseed oil, Camellia oil, Rose-hip-seed oil, Apricot-kernel oil, Niger-seed oil, Tea-seed oil, Hemp-seed oil, Black-mustard-seed oil, Shea-butter oil, Cacao butter and other vegetable oils, Fish oil, Animal fat (Tallow, Lard, Chicken Fat, Whale oil, Seal oil) is used as the food fat, and also those blend oil is acceptable. It is easy to blend flavors, such as oil, sesame oil and seasoning oil into the food fat. Those ingredients of the food fat (fruits and seeds, including the germ meal and after milling), oil mill (such as cold-pressed method), purified (de-gumming and de-acidification wintering) conditions such as oil, Hydrogenated esters and other processing conditions such as replacement blends conditions, DAG content and emulsion stability are different.

Many commercially available natural oils comprise DAG 1 to 20% (often 1 to 10%). The present invention of tofu coagulant, the food fat comprises DAG is 2% or more, is preferably. And the food fat comprises DAG is 5% or more, is more preferably. It is acceptable blended natural fat and processing fat, for example, the natural fat and processing fat ratio is between 1:0.01 and 1:100. There are limitations to blends cost-effective. Thus, the natural fat and processing fat ratio is between 1:0.02 and 1:1, is preferably. In case of blend uses blend method for the natural fat comprises a few DAG, thus, DAG 1% or more is obtained, and DAG 2% or more is obtained, further more DAG 5% or more is obtained. The invention is a tofu coagulant for tofu made from soybeans. Therefore, the emulsified tofu coagulant is vegetable oil is preferably. When uses the food fat, check DAG content and check oil quality, oil mill conditions, processing conditions and purification conditions, and also by other manufacturers and product upgrades. Because, those conditions are different to be DAG content is different.

Generally, most commercial food fats consist TAG mainly, and DAG is a few percent, is described in document 2 and 5. Innovators analyzed the commercial food fats at Japan institute of oil & fats, other foods inspection foundation. And the result is, rice oil comprises DAG 9.9%, cottonseed oil comprises DAG 7.8%, see Table 4. Cottonseed oil different of origin, and DAG is between 5.4 and 9.5%, is described in document 6. The present invention of a tofu coagulant comprising a mineral salt solution as water phase and a food fat as oil phase, without emulsifier including a diacylglycerol (DAG) is 1 wt % or more. The commercial food fat products comprise DAG between 1 and 20%, and processing fat comprises DAG between 40 and 99%. In particularly, the concentration of mineral salt solution is 2M or more. These findings are quite new and no other prior art.

DAG is a food fat component that is comprised a number of commercial oils. The food fat comprises Monoacylglycerol (MAG), and MAG is useful as an emulsifier. DAG is a fat which is same as conventional triacylglycerol (TAG). DAG MAG and TAG are belongs to Glycerin fatty acid Glycerol esters of fatty acids. Emulsification of DAG is weaker than MAG DAG is a fat which has a weak emulsification, is described in document 2. However, there is no commercial emulsifier which comprises DAG mainly. Fat product comprises DAG 40% or more, is produced by enzymatic reaction from glycerol and fatty acids, so treated as processing fat and not treated as emulsifier. Study to W/O type emulsion characteristic that is used 0.5M magnesium chloride solution and processing oil and does not use additives as emulsifiers, is disclosed in prior art document 2. The processing oil comprises DAG about 87%. The present invention refers DAG, is not into processing oil and it is into the food fat naturally. DAG is formed that one glycerol molecule, a form of carbon consisting of approximately C8˜C24 fatty acid molecule consisting of two. Most commercial oils contain that DAG, the difference in the difficulty of the content, but either can be used to the invention.

The present invention of a tofu coagulant, wherein the food fat is a plant-derived ingredient and comprising: phospholipid is 0.1% or less, monoacylglycerol is 1% or less, triacylglycerol is 98% or less, and diacylglycerol is 1% or more and 99% or less, is preferably. And the tofu coagulant, wherein acid value of the food fat is 0.1 or higher, or free fatty acids of the food fat is 0.05% or more, is preferably. When using commercial fat or commercially processed fats comprises relatively strong emulsification with lecithin and MAG coexistence with DAG, may have adverse effect on emulsion stability and slow-acting soymilk coagulation. Thus, phospholipid as lecithin is between 0 and 0.1% and MAG is between 0 and 1% that is preferably. High acid value is better within the Japanese Agricultural Standards. Free fatty acid content is calculated from the average molecular weight as well as acid value, and High free fatty acid content is better. The present invention of a tofu coagulant, wherein the free fatty acid content is 0.05% or more and acid value is 0.1% or more, is preferably. The free fatty acid has a weak emulsification. Those phospholipid, MAG and free fatty acid are almost rejected de-gumming and de-acidification wintering at purified process. TAG is a main content of fat in generally, is not important to this invention. Thus, TAG is between 0 and 98%. Others may be included in the trace, tocopherols (vitamin E), polyphenols and sterols are not affected by this invention thus, that content is not limited. Sometimes, the tempura frying oil products comprises small amount silicone defoamer. The silicone deformer affects to the surface tension of the oil, but the silicone deformer is almost no affective to the surface tension and emulsification of the oil for the present invention. For processed food products such as organic produce is not available sometimes, thus, preferable to select a product no containing silicone.

The present invention of a tofu coagulant, maximum amount of DAG is no upper limit, but, normally DAG is between few percents and 20%. And processing oil that comprises DAG 40% to 90% is available to single use or blend use for this invention. Generally, melting point of DAG is higher than TAG, thus, large amount of DAG is easy to solidify and affect stabilization of emulsification. In case of uses low melting point of DAG mainly, large amount of DAG is not to solidify and not affect stabilization of emulsification. In case of uses high melting point of DAG, warm and emulsified dispersion is preferably. Particularly, uses a fat that comprises high melting point of DAG, keeping a warm temperature higher than DAG melting point during emulsification that is easy to form W/O type emulsification. Because, it is no trouble happens that weighting and other operations, automatically. And after emulsification, can be kept W/O type emulsification into refrigerator for some days stable. For example, the emulsified tofu coagulant is warmed upper than melting point of DAG; and the fat is kept the liquid, before addition to soymilk, is preferably in the handling of the machine.

The present invention of a tofu coagulant, wherein the water phase and the oil phase ratio is between 1:0.2 and 1:3, preferably the ratio is between 1:0.4 and 1:1.5. The ratio is keeping material cost low, and under the oil phase ratio emulsification is not keeping stable. Over the ratio is affected material cost too higher. And the oil is not solid and the oil is necessary liquid during emulsification. And after emulsification, can be kept W/O type emulsification into refrigerator for some days stable. As above describe, warm the tofu coagulant before use. It can be use the tofu coagulant which oil phase is even if cloudy or solidify. High melting point of fat can be used such a palm oil and coconut oil. But, in case of use the high melting point of fat, the content of the fat is 50% or less, and preferably the content of the fat is 30% or less.

The present invention of a method for producing tofu coagulant, wherein interfacial tension of the food fat against distilled water is between 10 and 34 mN/m at room temperature. The invented tofu coagulant has stabilization of emulsification when food fat such DAG is few but interfacial tension of the food fat against distilled water is between 10 and 34 mN/m at room temperature.

The present invention of a method for producing tofu used the tofu coagulant, after 0.1 seconds from the stirred and mixed W/O type emulsion and before 3600 seconds due to the tofu coagulant mixture with soymilk. That is to say, the keeping time between the stirred and mixed W/O type emulsion and the mixture the tofu coagulant with soymilk that is between 0.1 and 3600 seconds. And the keeping time that is between 0.5 and 60 seconds, is preferably. According to the present invention, if the keeping condition is unstable, the keeping time between the stirred and mixed W/O type emulsion, and mixture the tofu coagulant and soymilk that is within 1 hour, preferably within 0.5 seconds to 1 minute, and easy to produce a smooth pudding-like tofu. For example, uses a certain oil such rice oil, olive oil and palm oil, the tofu coagulant with stable emulsion is obtained and if in this case, one day to several days after the emulsion preparation after storage at room temperature or keep refrigeration, and mixture the tofu coagulant and soymilk distribution, it is possible to get the same high-quality tofu. The tofu production method is similar to the normal method. That is to say, solids concentration 8 to 20% brix of soymilk 1 liter mixture and disperse with the tofu coagulant 0.1 to 6 g inorganic salts, and the soymilk temperature is 0 to 99 degC, is preferably.

### EFFECTS OF THE INVENTION

The present invention provides a tofu coagulant comprising a mineral salt solution as water phase and a food fat as oil phase including a diacylglycerol (DAG) is 1 wt % or more, and wherein the water phase and the oil phase are stirred and mixed to W/O type emulsion. According to the tofu coagulant, wherein the concentration of mineral salt solution is 2 M or more, is preferably. When target cooling temperature is below room temperature, indirect cooling means such as water chillers and water cooled refrigerant is better. The present invention of tofu coagulant, the food fat comprises DAG 1% or more. Any emulsifier is not comprised in the invention tofu coagulant. It is easy to select Nigari and fat as for consumer's request, thus, tofu product differentiation can be enhanced with the creation of flavor diversity. More over, any silicone is not comprised in the invention tofu coagulant, thus, tofu products are truly natural food. And easy to follow processed foods organic produce such Japan agriculture standard.

And produce silken tofu used as above the tofu coagulant, obtains smooth skin, high water retention, with the original flavor of tofu, honed to a silken tofu-like elasticity and hardness of water-holding firm. For example, solids concentration 8 to 16% brix of soymilk 1 liter mixture and distribute with the tofu coagulant 0.1 to 0.5% as magnesium chloride (hexahydrate), and the soymilk temperature is 0 to 99 degC, is preferably. According to the invention, controls such as cooling and emulsifying, and the water phase Nigari and the oil phase fat are stirred and mixed to W/O type emulsion, easily. Therefore, the tofu coagulant characterised slow-acting coagulating reaction is obtained by low cost. The scope of the invention, as well as silken tofu, kinugoshi-tofu, momen-tofu, namaage-tofu, atuage-tofu, can utilize a variety of tofu products.

### BRIEF DESCRIPTION OF THE DRAWINGS

FIG. 1 is a schematic view illustrating a tofu curding system with one-way continuous path according to the present invention.

FIG. 2 is a schematic view illustrating a tofu curding system with one-way continuous path and heat exchanger attached according to the present invention.

FIG. 3 is a schematic view illustrating a tofu curding system with circular path according to the present invention.

### DETAILED DESCRIPTION OF THE INVENTION

Next, the description will be made concerning concrete embodiments according to the present invention by referring to the drawings.

Machine Explanation

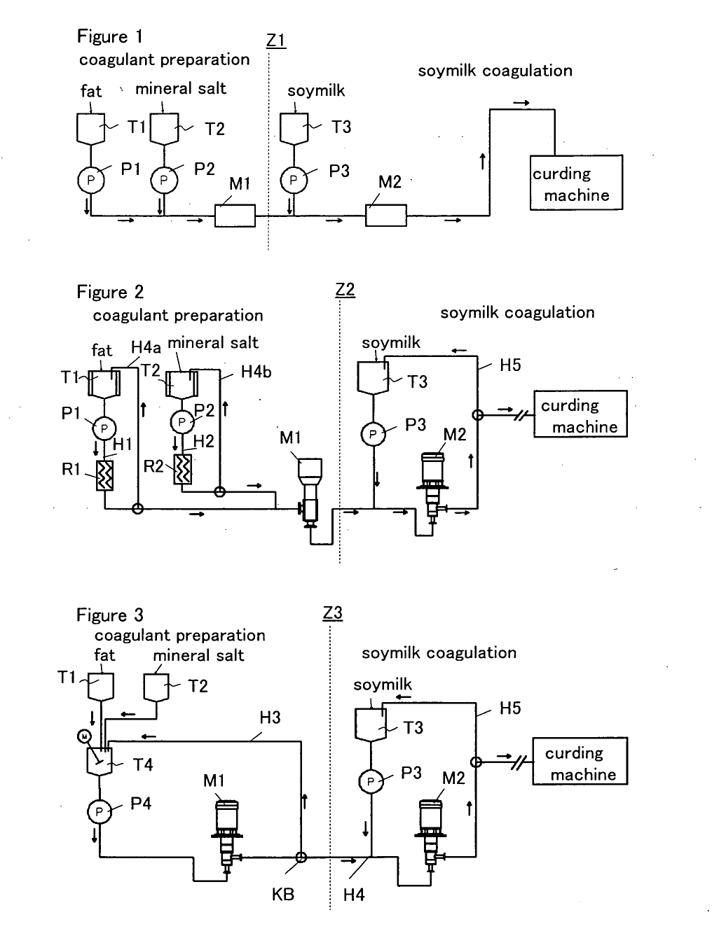

According to the invention, FIG. 1 shows a tofu curding system Z1 with one-way continuous path, and FIG. 2 shows a tofu curding system Z2 with one-way continuous path and cooling means R1 and R2 attached, and FIG. 3 shows a tofu curding machine Z3 with circular path H3. The tofu curding system Z1 and Z2 are continuous type, and the tofu curding system Z3 is batch type. Continuous type tofu curding system Z1 (Z2) is consist coagulant preparation part and soymilk coagulation part. Coagulant preparation part is, pre-mixture a food fat and a mineral salt solution as Nigari separately, and sending each material to an emulsifying dispersion machine M1 by pumps P1, P2 and make a emulsified tofu coagulant, see in FIG. 1. Soymilk coagulation part is mixture the tofu coagulant and high-temperature soymilk from tank T3, and sending mixture materials to a coagulation dispersion machine M2 by pump P3, and sending pre-product to curding machine, continuously as see in FIG. 1. Tofu curding system Z2 comprises cooling means (heat exchangers) R1, R2. Cooling means R1 is attached pipe H1 that output of pump P1. Cooling means R2 is attached pipe H2 that output of pump P2. Either cooling means R1 or R1 is able to work. Tofu curding system Z2 comprises fat circular path H4a, mineral salt solution circular path H4b and soymilk circular path H5, is shown in FIG. 2.

Also, batch type tofu curding system Z3 is consist coagulant preparation part and soymilk coagulation part. Coagulant preparation part is, pre-mixture a food fat and a mineral salt solution as Nigari at tank T4 together in, and sending mixtures material to an emulsifying dispersion machine M1 by a pump P4 and make a tofu coagulant, see in FIG. 3. Stirring and mixture equipment is attached to tank T4. Switching valve KB is attached output of the emulsifying dispersion machine M1 and can be return overflow of the tofu coagulant to the tank T4. Soymilk coagulation part is mixture the tofu coagulant and high-temperature soymilk from tank T3, and sending mixture material to a coagulation dispersion machine M2 by pump P3, and sending pre-product to curding machine, as see in FIG. 3. Tofu curding system Z3 can be set cooling means (heat exchangers) on pipe H3 and tank T4, and can be set cooling means (heat exchangers) on pipe H4.

Emulsifying dispersion machine M1 has the strong performance of the emulsified dispersion, and preferably high-pressure homogenizer stator and rotor-type high-rotation type mixing, static mixers even better. The disperser coagulated dispersion machine M2, is weaken rather than machine M1 is no problem. For example, static mixer such a made by Noritake, and static mixer TS manufactured by Takai Tofu & Soymilk Equipment Co., is used to machine M2.

According to the invention of the tofu coagulant comprises a mineral salt solution as water phase and a food fat as oil phase. The tofu coagulant is not included synthetic emulsifiers and stabilizers that both food additives are necessary to uses current emulsification. According to the tofu coagulant, wherein the mineral salt solution comprising at least any one of a magnesium chloride, calcium chloride, sodium chloride, potassium chloride, magnesium sulfate, magnesium chloride seawater crude, in particular the magnesium chloride as Nigari. The invention, Nigari is acceptable including less than the solubility of calcium sulfate, calcium sulfate and particulate matter, and organic acids such as citric acid and gluconic acid.

The present invention of tofu coagulant has food fat that comprises DAG between 1% or more. The invention uses the food fat as liquid condition that can be use translucent or milky-white either. Just, it is necessary to use liquid food fat. That is to say, at least before the emulsifying dispersion, keep the food fat temperature higher than it maximum melting point. The DAG is natural ingredient of the food fat. The present invention of tofu coagulant can use the commercial food fat. For example, Rice oil, Corn oil, Soybean oil, Rapeseed oil, Sesame oil, Palm oil, Olive oil, Virgin-olive oil, Pure-olive oil), Grape-seed oil, Hazelnut oil, Palm oil, Cottonseed oil, Peanut oil, Macadamia-nut oil, Almond oil, Avocado oil, Linseed oil, Pumpkinseed oil, Walnut oil, Sesame oil, comprises DAG between 1 and 10%, see table 4.

DAG content is depended on oil material, oil expression and purification. For example, virgin olive oil and pure olive oil comprises DAG, but content of DAG are deference. The invention, mixture virgin olive oil and pure olive oil, is no problem and it can be control emulsification stability and slow-acting characteristic by deferent DAG contents mixture. The food fat comprises Monoacylglycerol (MAG) 1% or less and the food fat is not contains lecithin (phospholipid) such as emulsification, preferably. Lecithin and MAG are cause of weak slow-acting. Salad oil is acceptable that rejected depositions by wintering, but DAG content should be keep 1% or more.

Table 4 shows emulsion easiness that how easy to W/O emulsion after emulsifying dispersion, emulsion stability that how keep W/O emulsion warms 45 degC. Emulsion stability test procedure is, put the emulsion on glass plate and put cover glass on it and immediately view and photo by digital microscope (manufactured by Keyence Corporation named VHX-500F), after that input it chamber 45 degC and 1 hour, after that put out it and view and photo again, and compare both emulsions different. Measure particle diameters in photos and calculate particle size distribution.

Emulsifying dispersion temperature is depends on melting point of fat. In case of the fat temperature is 45 degC, most of food fat is liquid. Emulsifying dispersion condition is adjustable such 35 degC and 2 hours or more, 25 degC and 4 hours or more, 15 deg C. and 8 hours or more, degC and 16 hours or more. The invention of tofu coagulant, water phase size average is between 0.1 and 20 micro meter, average between 1 and 10 micrometer is preferably, average between 1 and 5 micrometer is more preferably.

According to the present invention, when the fat is solidified, pre-warmed over the melting point and liquid fat is stirred and mixed. And when the fat is solidified by cooling after emulsified, pre-warmed over the melting point and liquid the emulsified tofu coagulant is used before addition to soymilk. When use a fat easy to solidify, attaches a keeping heat means on pipes, tanks, and valves, preferably.

### Example 1

Magnesium chloride solution as Nigari that is made by AKO KASEI CO., LTD., that named Soft-Wafer. Food fat is pure olive oil made by J-OIL MILLS, Inc. Temperature of the magnesium chloride solution is 19.1 degC, and temperature of the olive oil is 10.3 degC or 4.1 degC. The food fat is not including silicone. Magnesium chloride and water ratio is 2:1, and make a magnesium chloride solution that concentration is 66.7% w/w as density 1.34 and 4.3 M. Pre-mixture the magnesium chloride solution 500 g and olive oil 500 g separately, and sending each material to an emulsifying dispersion machine M1 and make a emulsified tofu coagulant. Emulsifying dispersion machine M1 is manufactured by Pacific Machinery & Engineering Co., Ltd., named Milder for laboratory. Machine M1 rotor speed is 10000 rpm and squeezing out put valve and continuously emulsifying and dispersion, and make the tofu coagulant. Coagulation dispersion machine M2 is manufactured by PRIMIX Corporation, named Homo-mixer Mark 2-40 type. Curding machine is batch type and manufactured by Takai Tofu & Soymilk Equipment Co., named Mini-Curdy. The coagulation dispersion machine M2 is attached on the curding machine. The tofu curding system Z1 is same as FIG. 1, but cooling mean is addition to tank and cooling water temperature is 10 degC.

For tofu curding action, prepare soymilk for silken tofu 13% brix, temperature 80 degC, 12 liter input flat box. The tofu coagulant amount, concentration of magnesium chloride solution that converted to magnesium chloride (hexahydrate) weight 2.8 g for soymilk 1 liter. The emulsified tofu coagulant within 60 minutes after emulsifying and dispersion, is input the soymilk and stirred and dispersed about 20 seconds by coagulation dispersion machine M2 that rotation speed 2000 rpm, and make a tofu. To aged, wait 30 minutes after made the tofu, and evaluate the tofu checking by visual, touching and eating. See table 1. As the result, example 1-1, example 1-3 are produced a smooth pudding-like silken tofu. In case of example 1-2 is shorten emulsifying time 0.5 minutes, thus emulsion temperature increase near 30 degC by stir heat as friction heat. Therefore, the emulsion was unstable and slightly rough surface of the tofu and emergent. Example 1-1 is used cooling means and suppressed the emulsion temperature after emulsification. Example 1-3 is pre-cooled the fat and suppressed the emulsion temperature after emulsification. The comparative examples, that only Nigari input the soymilk 80 degC and stirred and dispersed, is a rough surface weak tofu, so it is not show in table 1.

TABLE 1

| | | Fat | Nigari | Emulsifying | Coagulant | |
|---|---|---|---|---|---|---|
| | Cooling | temperature | Temperature | time | Temperature | Tofu |
| | means | (deg C.) | (deg C.) | (sec.) | (deg C.) | Evaluation |
| Example 1-1 | yes | 10.3 | 19.1 | 120 | 22.3 | good |
| Example 1-2 | no | 10.3 | 19.1 | 050 | 29.0 | not so good |
| Example 1-3 | yes | 04.1 | 03.6 | 230 | 19.0 | very good |

### Example 2

Magnesium chloride solution as Nigari that is made by Naikai Salt Industries CO., LTD., that named White-Nigari. Food fat is pure olive oil made by J-OIL MILLS, Inc. Magnesium chloride solution is into freezer, and olive oil is into refrigerator. Temperature of the magnesium chloride solution is −7 degC, and temperature of the olive oil is 4.1 degC. The food fat is not including silicone. Magnesium chloride and water ratio is 2:1, and make a magnesium chloride solution that concentration is 66.7% w/w as density 1.34 and 4.3 M. Pre-mixture the magnesium chloride solution 500 g and olive oil 500 g separately, and sending each material to an emulsifying dispersion machine M1 and make a tofu coagulant. Emulsifying dispersion machine M1 is manufactured by Pacific Machinery & Engineering Co., Ltd., named Milder for laboratory. Machine M1 rotor speed is 10000 rpm and squeezing out put valve and continuously emulsifying and dispersion, and make the tofu coagulant. Coagulation dispersion machine M2 is connected two mixers which one is manufactured by Noritake Co., Ltd., and other is manufactured by Takai Tofu & Soymilk Equipment Co., The coagulation dispersion machine M2 is attached on the curding machine. The tofu curding system Z1 is same as FIG. 1.

For tofu curding action, prepare soymilk for silken tofu 13% brix, temperature 80 degC and continuously flow, and addition the tofu coagulant after made within 5 or 60 minutes. The tofu coagulant amount, concentration of magnesium chloride solution that converted to magnesium chloride hexahydrate weight 2.5 g for soymilk 1 liter. The soymilk flow 200, 300 and 400 liter/hour, and receive it to a box as 3 liters, and check the product slow-acting time by visual. Slow-acting time is between into the box and beginning to curd. To aged, wait 30 minutes after made the tofu, and cut out to cylindrical tofu that diameter 20 mm and height 20 mm, and set it on Rheometer, and evaluate the tofu hardness. Rheometer is manufactured by Fudo Engineering Co., Ltd., named NRM-2002J and plunger diameter 20 mm, sample table rising speed 60 mm/minute. And evaluate the tofu checking by visual, touching and eating. See table 2. As the result, example 2-2 is produced a smooth pudding-like silken tofu. Example 2-2 as soymilk flow 300 liter/hour is made a most hard tofu. Example 2-1 as soymilk flow 200 liter/hour is made a little soft tofu. Example 2-3 as soymilk flow 420 liter/hour is made a little rough surface tofu.

TABLE 2

| | | Fat | Nigari | Slow-acting | Tofu | |
|---|---|---|---|---|---|---|
| | Tofu flow | temperature | Temperature | time | hardness | Tofu |
| | (Liter/hour) | (deg C.) | (deg C.) | (sec.) | (×10² N/m²) | Evaluation |
| Example 2-1 | 200 | 4.1 | −7 | 30.0 | 81.2 | good |
| Example 2-2 | 300 | 4.1 | −7 | 12.3 | 89.2 | very good |
| Example 2-3 | 420 | 4.1 | −7 | 05.4 | 83.7 | good |

### Example 3

Magnesium chloride solution as Nigari that is made by Naikai Salt Industries CO., LTD., that named White-Nigari. Food fat is selected one of the, cone oil (made by Boso oil and fat CO., LTD.) and palm oil (made by Fuji oil CO., LTD.) mixtures ratio 1:1, soybean oil (made by J-OIL MILLS), rice oil (made by J-OIL MILLS), cone oil (made by Boso oil and fat CO., LTD.), rapeseed oil (made by J-OIL MILLS). Temperature of Nigari is 13 degC, and each temperature of the oil is 13 degC. The food fat is not including silicone. Magnesium chloride and water ratio is 2:1, and make a magnesium chloride solution that concentration is 66.7% w/w as density 1.34 and 4.3 M. Pre-mixture the magnesium chloride solution 500 g and olive oil 500 g separately, and sending each material to an emulsifying dispersion machine M1 and make a tofu coagulant. Emulsifying dispersion machine M1 is manufactured by Pacific Machinery & Engineering Co., Ltd., named Milder for laboratory. Machine M1 rotor speed is 10000 rpm and squeezing out put valve and continuously emulsifying and dispersion, and make the tofu coagulant. Coagulation dispersion machine M2 is connected two mixers which one is manufactured by Noritake Co., Ltd., and other is manufactured by Takai Tofu & Soymilk Equipment Co., The coagulation dispersion machine M2 is attached on the curding machine. The tofu curding system Z1 is same as FIG. 1. Curding machine is batch type and manufactured by Takai Tofu & Soymilk Equipment Co., named Mini-Curdy, and rotation speed is 2000 rpm.

For tofu curding action, prepare soymilk for silken tofu 13% brix, temperature 80 degC and continuously flow, and addition the tofu coagulant after made within 5 or 60 minutes. The tofu coagulant amount, concentration of magnesium chloride solution that converted to magnesium chloride hexahydrate weight 2.8 g for soymilk 1 liter. The soymilk flow 200, 300 and 400 liter/hour, and receive it to a box as 3 liters, and check the product slow-acting time by visual. Slow-acting time is between into the box and beginning to curd. To aged, wait 30 minutes after made the tofu, and cut out to cylindrical tofu that diameter 20 mm and height 20 mm, and set it on Rheometer, and evaluate the tofu hardness. Rheometer is manufactured by Fudo Engineering Co., Ltd., named NRM-2002J and plunger diameter 23 mm, sample table rising speed 60 mm/minute. And evaluate the tofu checking by visual, touching and eating. See table 3.

As the result, example 3-2 uses as soybean oil is acceptable, made a smooth and hard tofu, but slow-acting time is shorten and little weak. Because, content of soybean oil DAG is rather smaller than the cone oil DAG and palm oil DAG Example 3-3, example 3-4 and example 3-5 are produced a smooth and hard tofu, and cone oil, rice oil, rapeseed oil each is able to prepare the emulsified tofu coagulant. As the result, example 3-1 uses as mixtures cone oil and palm oil, slow acting time is enough, and made a smooth tofu, but hardness is not enough a little. Cone oil and palm oil comprise DAG relatively high and low cost. Palm oil has slow-acting character and high melting point. Thus, palm oil and cone oil mixtures ratio is between 1:1 and 1:10, is obtained liquid food fat, and easy to handling, made a smooth and hard tofu.

TABLE 3

| | | Fat and Nigari | Slow-acting | Tofu | |
|---|---|---|---|---|---|
| | Fat | temperature | time | hardness | Tofu |
| | (oil type) | (deg C.) | (sec.) | (×10² N/m²) | Evaluation |
| Example 3-1 | Cone and Palm | 13 | 40 | 47.1 | very good |
| Example 3-2 | Soybean | 13 | 15 | 53.0 | good |
| Example 3-3 | Rapeseed | 13 | 30 | 45.1 | good |
| Example 3-4 | Cone | 13 | 25 | 48.0 | good |
| Example 3-5 | Rice | 13 | 30 | 58.8 | good |

### Example 4

Table 4 (table 4-1, table 4-2 and table 4-3) shows emulsion easiness that how easy to W/O emulsion after emulsifying dispersion, emulsion stability that how keep W/O emulsion during warms 45 degC. Emulsifying dispersion test is used such a tofu curding system Z3 is batch type. Coagulation dispersion machine M2 is manufactured by Yamato Scientific Co., Ltd, named Ultra-disperser LK-22 with generator shaft: S-25N-10 G, and it rotation speed is 20,000 rpm. Stir the fat 50 g and added 4M magnesium chloride 50 g and emulsifying 3 minutes.

As shown in table 4, correlation between DAG content and emulsion easiness is high, and correlation between DAG content and emulsion stability is high. But, correlation between MAG content and emulsion easiness is low, and correlation between MAG content and emulsion stability is low. DAG content is depended on oil material, oil expression and purification. Thus, same material but DAG content is different. In the table 4, plant oil comprises DAG between 1 and 10%. The invention, the food fat is a plant-derived ingredient and comprising phospholipid is 0.1% or less, monoacylglycerol is 1% or less, triacylglycerol is 98% or less. According to palm oil, cone oil and pure olive oil, warms 45 degC and 120 minutes and confirms emulsion stability. Virgin olive oil, soybean oil and palm oil are rather unstable. Macadamia-nut oil, Safflower oil, Perrila Oil can't confirms emulsion stability. If use tofu curding system Z2 with one-way continuous path and cooling means R1 and R2 attached, those Macadamia-nut oil, Safflower oil, Perrila Oil will be reach more stable emulsion. Only DAG is a good correlation with emulsion easiness or emulsion stability, as shown in table 4. Those phospholipid, MAG and free fatty acid are almost rejected de-gumming and de-acidification wintering at purified process. TAG is a main content of fat in generally, is not important to this invention. Thus, TAG is between 0 and 98%. DAG is a fat which is same as conventional TAG As Japanese Agricultural Standards, acid value most of the food fat is 0.2 or less. Sesame oil acid value is 4 or less, and Olive oil acid value is 2 or less. The invention, food fat means food plant oil or food processing oil specified Japanese Agricultural Standards or same Standards. Table 4 shows a part of food fats applicable to the invention. Therefore, the food fat is not limited and it can be use meet the conditions of the invention.

Table 4 (table 4-1, table 4-2 and table 4-3) shows characteristics of plant oils. Emulsion easiness (*a) is how easy to W/O emulsion after emulsifying dispersion on batch test, and scale with 10 points. Emulsion stability (*b) is how keep W/O emulsion during warms 45 degC on batch test, and scale with 10 points. Free fatty acid value (*c) is calculated that is ((acid value/56)×(average molecular weight−38)/3/1000)×100. Saturated fatty acid (*d) and Double bond (*d) are calculated fatty acid composition. MAG (*1), DAG (*1) and TAG (*1) are analyzing result of Japan institute of oil & fats, other foods inspection foundation. DAG literature (*2) is cited R. P . D'alonzo, W. J. Kozarek and R. L. Wade.: J. Am. Oil Chem. Soc., 59, 292, Year 1982, Journal of the American Oil Chemists' Society. Acid value (*3) is measured by Takai Tofu & Soymilk Equipment Co.: Viscosity (*4) is measured by Takai Tofu & Soymilk Equipment Co., and used B type viscosity meter with BL adapter.

TABLE 4

| | | Palm | Cone | Pure olive | Virgin olive |
|---|---|---|---|---|---|
| | | oil | oil | oil | oil |
| Emulsion easiness (*a) | | 7 | 5 | 5 | 3 |
| Emulsion stability (*b) | min. | 120 | 120 | 120 | 60 |
| MAG (*1) | % | 0.2 | 0.8 | 1.0 | 0.4 |
| DAG measured (*1) | % | 7.5 | 5.2 | 5.4 | 3.6 |
| DAG literature (*2) | % | 5.8 | 2.8 | 5.5 | 5.5 |
| TAG (*1) | % | 92.7 | 94.4 | 94.4 | 94.9 |
| Acid value (*3) | | 0.11 | 0.13 | 0.18 | 0.76 |
| Fatty acid value (*c) | % | 0.05 | 0.05 | 0.09 | 0.38 |
| Saturated fatty acid (*d) | % | 50.7 | 14.3 | 14.2 | 14.2 |
| Double bond (*d) | % | 1.8 | 4.0 | 2.8 | 2.8 |
| Viscosity at room (*4) | mPa · s | 70 | 52 | 62 | — |
| Viscosity at 10 deg C. (*4) | mPa · s | — | 108 | 133 | 133 |
| Slow-acting character | | very good | very good | very good | good |

| | | Rice | Cotton seed | Peanut | Soybean |
|---|---|---|---|---|---|
| | | oil | oil | oil | oil |
| Emulsion easiness (*a) | | 7 | 7 | 2 | 2 |
| Emulsion stability (*b) | min. | 120 | 20 | 90 | 20 |
| MAG (*1) | % | 0.4 | 0.3 | 0.5 | 0.4 |
| DAG measured (*1) | % | 9.9 | 7.8 | 3.6 | 3.2 |
| DAG literature (*2) | % | — | 3.1 | 2.2 | 1.0 |
| TAG (*1) | % | 89.7 | 91.3 | 95.7 | 97.2 |
| Acid value (*3) | | 0.16 | 0.12 | 0.20 | 0.10 |
| Fatty acid value (*c) | % | 0.08 | 0.06 | 0.10 | 0.05 |
| Saturated fatty acid (*d) | % | 21.6 | 26.2 | 13.4 | 14.7 |
| Double bond (*d) | % | 3.6 | 3.9 | 3.6 | 4.6 |
| Viscosity at room (*4) | mPa · s | 73 | 55 | 72 | 49 |
| Viscosity at 10 deg C. (*4) | mPa · s | 133 | 114 | 122 | 100 |
| Slow-acting character | | good | good | not so good | not so good |

| | | Coconut | Rapeseed | Macadamia | Safflower |
|---|---|---|---|---|---|
| | | oil | oil | nut oil | oil |
| Emulsion easiness (*a) | | 2 | 2 | 0 | 0 |
| Emulsion stability (*b) | min. | 20 | 60 | 0 | 0 |
| MAG (*1) | % | 0.5 | 0.4 | 0.3 | 0.4 |
| DAG measured (*1) | % | 2.5 | 3.2 | 2.2 | 2.4 |
| DAG literature (*2) | % | 2.2 | — | — | 2.1 |
| TAG (*1) | % | 97.2 | 96.1 | 97.5 | 96.6 |
| Acid value (*3) | | 0.11 | 0.12 | 0.06 | 0.08 |
| Fatty acid value (*c) | % | 0.04 | 0.06 | 0.03 | 0.04 |
| Saturated fatty acid (*d) | % | 30.4 | 26.2 | 10.3 | 11.3 |
| Double bond (*d) | % | 0.3 | 3.9 | 2.6 | 4.9 |
| Viscosity at room (*4) | mPa · s | 52 | 55 | 73 | 55 |
| Viscosity at 10 deg C. (*4) | mPa · s | — | 117 | 135 | 129 |
| Slow-acting character | | not so good | not so good | bad | bad |

To study relation between mineral salt concentration and tofu quality included coagulant cost, is as shown in table 5 (table 5-1 and table 5-2). Use the tofu curding system Z1 with one-way continuous path as shown in FIG. 1. Particularly, use the tofu curding system Z2 with one-way continuous path and cooling means R1 and R2 attached as shown in FIG. 2. It is effective suppressed stirring heat up and keeping emulsion stable. Invention example is used olive oil that consist DAG 5.4% w/w. Comparative example is used safflower oil that consist DAG 2.4% w/w. Mineral salt solution is used 1M magnesium chloride, 2M magnesium chloride, 4M magnesium chloride, 4M calcium chloride. 4M magnesium chloride and 4M calcium chloride are saturated aqueous solution at room temperature. Mineral salt solution (water phase) and the food fat (oil phase) ratio is between 1:0.2 and 1:3, preferably the ratio is between 1:0.4 and 1:1.5. Emulsion is cooled 50 degC or less on the emulsifying or after the emulsifying for keeping emulsion stable. In case of cone oil, melting point is between −15 and −10 degC. Thus, cone oil cooling temperature is between 10 and 25 degC when just emulsified at 30 degC. In case of palm oil, melting point is between 27 and 50 degC in literature, but actual melting point is 60 degC and after that it is not milky near 30 degC by warm test. Thus, palm oil cooling temperature is between 30 and 50 degC when just emulsified at 60 degC or near. Emulsion viscosity is higher and stable when the oil phase is smaller, tendency. Commercial emulsifier tofu coagulant viscosity is between 1 and 2 Pa·s at room temperature which is concerned handling put out bottle. As above describe, in the invention doesn't need bottle and when uses the system Z1, Z2, Z3, invention tofu coagulant viscosity 2 to 10 Pa·s is acceptable to use, also invention tofu coagulant viscosity 10 to 100 Pa·s is possible to use when select high power pump.

Table 5 (table 5-1 and table 5-2) shows relation between mineral salt concentration and tofu quality included coagulant cost. Coagulant basis is commercial emulsifier tofu coagulant that is made by Kao Corporation named Magness-fine TG

TABLE 5

| | Comparative | Example | Example | Comparative | Example | Example | Comparative |
|---|---|---|---|---|---|---|---|
| | 5-1 | 5-1 | 5-2 | 5-2 | 5-3 | 5-4 | 5-3 |
| Mineral salt solution | 1M | 2M | 4M | 4M | 4M | 2M | 4M |
| | MgCl₂ | MgCl₂ | MgCl₂ | MgCl₂ | CaC1₂ | MgCl₂ | MgCl₂ |
| Food fat | Olive oil | Olive oil | Olive oil | Safflower oil | Olive oil | Olive oil | Olive oil |
| Water phase: Oil phase ratio | 1:1 | 1:1 | 1:1 | 1:1 | 1:1 | 1:0.2 | 1:3.5 |
| Emulsion stability at 45 deg C. | very good | very good | good | NG | good | good | very good |
| | | | | separated | | separated | |
| | | | | few minutes | | 1 hour | |
| Slow-acting character | very good | very good | very good | NG | very good | good | very good |
| Tofu condition | soft | a little soft | hard | weak, | hard | hard | a little soft |
| | | | | emergent | | | oily smell |
| Cost of coagulant | too high | a little high | half cost | half cost | half cost | half cost | too high |
| | NG | OK | OK | OK | OK | OK | NG |

Actually, the water phase and the oil phase ratio is between 1:0.5 and 1:1.5 that is economical cost range. In case of the oil phase is smaller, emulsion is unstable and slow-acting character is low. In case of the oil phase is bigger, addition amount to tofu is increased and cost is getting high.

The invention of tofu coagulant, the concentration of magnesium chloride is 2 M or more. The dense magnesium chloride concentration between 3 and 5 M, is preferably, and upper limit is 6.1 M or under. Saturated aqueous solution of magnesium chloride is 4.8 M at 10 degC, 5 M at 40 degC, 5.6 M at 80 degC, 6.1 M at 100 degC, for example. Magnesium chloride 6.1 M is maximum, cause 100 degC is upper limit. Saturated aqueous solution of magnesium sulfate is 3.8 M maximum, and calcium chloride is 8.8 M maximum. It can be use the tofu coagulant which water phase is even if cloudy or part of solidify. Also, it can be use the tofu coagulant which oil phase is slurry such a calcium sulfate particles included. But it is not useful, because the emulsified tofu coagulant unstable and pump and pipe are affected deposition of the oil phase.

Practically, it is necessary to increase oil phase (continuous phase) as water phase (disperse phase) amount. Thus, decreasing water phase and suppressing the oil phase volume that is advantageously to cost reduction. Moreover, increasing the concentration of magnesium chloride in the water phase, fewer usages to the coagulant and possibly reaches more cost reduction. Study to W/O type emulsion characteristic that is used 0.5M magnesium chloride solution and processing oil and does not use additives as emulsifiers, is disclosed in prior art document 2. Refer FIG. 1 of prior art document 2, dense magnesium chloride and dense calcium chloride is unstable, estimation, but, emulsion is stable cause of emulsion viscosity increasing. Dense mineral salt solution is specially damaged heat up by stirring heat and dissociation effect. Therefore, in the invention, uses one-way continuous path and cooling means at system Z2. Most of commercial magnesium chloride seawater crude is 2 M or more. Concentration 2M is sum of magnesium chloride mol, magnesium sulfate mol, calcium chloride mol and calcium sulfate mol in solution 1 liter.

The present invention of a method for producing tofu coagulant, wherein interfacial tension of the food fat against distilled water is 34 mN/m or less at room temperature. The water phase as magnesium chloride and the oil phase such olive oil and rice bran oil are stirred and mixed to W/O type emulsion. DAG interfacial tension is low, and the content of DAG effect to total food fat interfacial tension to decrease, and emulsion is stabilized by the action of surface-active phase. TAG and DAG interfacial tension is cited prior art document 3. However, relation between DAG content and food fat interfacial tension is not disclosed. Moreover, about W/O type emulsion, relation between mineral salt solution as Nigari and DAG content of food fat is not disclosed.

### Example 6

For about typically food fat, measure the interfacial tension at room temperature. Test equipment is manufactured Kyowa Interface Science Co., ltd. named DropMaster DM301. Perrila oil and macadamia-nut oil are sample that is difficult emulsifying. Table 6 shows characteristics of plant oils. Processing oil* is commercial processing oil include DAG highly. Emulsion easiness (*a) is how easy to W/O emulsion after emulsifying dispersion on batch test, and scale with 10 points. Emulsion stability (*b) is how keep W/O emulsion during warms 45 degC on batch test, and scale with 10 points.

TABLE 6

| | Comparative | Comparative | Example | Example | Comparative |
|---|---|---|---|---|---|
| | 6-1 | 6-2 | 6-1 | 6-2 | 6-3 |
| Food fat | Perrila | Macadamia- | Soybean | Cone | Processing |
| | oil | nut oil | oil | oil | oil* |
| Interfacial tension | 34.2 | 29.2 | 32.5 | 26.1 | 12.5 |
| (mN/m) | | | | | |
| Emulsion easiness (*a) | 0 | 0 | 2 | 5 | 10 |
| Emulsion stability (*b) | 0 | 0 | 2 | 10 | 10 |
| DAG (%) | 3.6 | 2.2 | 3.2 | 5.2 | 87.1 |

As shown in table 6, when the interfacial tension at room temperature over the 34 mN/N, difficult to emulsion and unstable. In the invention, the interfacial tension at room temperature is 34 mN/m or less, particularly the interfacial tension 30 mN/m or less, which is easy obtained W/O type emulsion and stable condition. See table 6. As comparative 6-1, Perrila oil interfacial tension is 34.2 mN/m that why Perrila oil couldn't to be emulsion. As example 6-1, Soybean oil interfacial tension is 32.5 mN/m that why Soybean oil could be emulsion. Perrila oil DAG content is 3.6%, and Soybean oil DAG content is 3.2%. Therefore, according emulsification, the interfacial tension is more effective than DAG content. On the other hand, Macadamia-nut oil DAG is 2.2%, and Soybean oil DAG content is 3.2%. In case of it, as comparative 6-2, Macadamia-nut oil DAG is 2.2% that why Macadamia-nut oil couldn't to be emulsion. If a surface-active agent into the emulsifier, the interfacial tension is below 10 mN/m. Therefore, according to the invention, wherein interfacial tension of the food fat against distilled water is between 10 and 34 mN/m at room temperature, and particularly the interfacial tension is between 10 and 30 mN/m. The food fat as oil phase including DAG is 1 wt % or more, and particularly DAG is 3 wt % or more, and/or, the interfacial tension is between 10 and 34 mN/m, and particularly the interfacial tension is between 10 and 30 mN/m. Refer to such Cone oil DAG 5.2% and interfacial tension 26.1, or Soybean oil DAG 3.2% and interfacial tension 32.5, or Processing oil DAG 87.1% and interfacial tension 12.5. See table 6. The food fat interfacial tension is decreased when temperature is increased. In case of it, advantageous to emulsify, but emulsion viscosity is decreased and doing to re-aggregate and unstable emulsified phase. In case of the interfacial tension of the food fat is between 10 and 34 mN/m and DAG is less than 1 wt % that is difficult to emulsify and unstable.

The invention of tofu coagulant, water phase size (diameter) average is between 0.1 and 20 micro meter, average between 1 and 10 micrometer is preferably, average between 1 and 5 micrometer is more preferably. According to the present invention, when the water phase size average is bigger than criteria, emulsification is unstable. In opposition, when the water phase size average is smaller than criteria, emulsification viscosity is increased and difficult to measure and difficult to disperse in soymilk and cause of coagulating irregular. To measure on flow meter the water phase diameter, put the emulsion on glass plate and put cover glass on it and immediately view and photo by digital microscope (manufactured by Keyence Corporation named VHX-500F, and high-resolution lens VH-Z500W) by transmission shooting, after that measure particle diameters in photos 100 micrometer square area, and measure particle diameter by compass and calculate average diameter, median diameter and standard deviation. The water phase size is able to control by food fat, temperature and machine conditions. When the water phase size is smaller, coagulation slow-acting effect is up. In opposition, when the water phase size is bigger, coagulation slow-acting effect is down. As above embodiments, the soymilk temperature is between 0 and 99 degC, the temperature between 60 and 95 degC is preferably, and the temperature between 75 and 85 degC is practical and more preferably.

As above embodiments, describe producing method for silken tofu. The scope of the invention, as well as silken tofu, kinugoshi-tofu, momen-tofu, namaage-tofu, atuage-tofu, can utilize a variety of tofu products.

1. A tofu coagulant, comprising: a mineral salt solution as water phase; a food fat as oil phase including a diacylglycerol is 1 wt % or more, and wherein the water phase and the oil phase are stirred and mixed to W/O type emulsion.

2. A tofu coagulant according to claim 1, wherein the concentration of mineral salt solution is 2 M or more.

3. A tofu coagulant according to claim 1, wherein the mineral salt solution comprising at least any one of a magnesium chloride, calcium chloride, sodium chloride, potassium chloride, magnesium sulfate, magnesium chloride seawater crude.

4. A tofu coagulant according to claim 1, wherein the water phase and the oil phase ratio is between 1:0.2 and 1:3, preferably the ratio is between 1:0.4 and 1:1.5.

5. A tofu coagulant according to claim 1, wherein the food fat is a plant-derived ingredient and comprising: phospholipid is 0.1% or less, monoacylglycerol is 1% or less, triacylglycerol is 98% or less.

6. A tofu coagulant according to claim 5, wherein acid value of the food fat is 0.1 or higher, or free fatty acids of the food fat is 0.05% or more.

7. A method for producing tofu coagulant includes a mineral salt solution as water phase and a food fat as oil phase including a diacylglycerol is 1 wt % or more, comprising: a stirring and mixing step of the water phase and the oil phase to W/O type emulsion.

8. A method for producing tofu coagulant according to claim 7, wherein at least one of the water phase or the oil phase is cooled during the stirring and mixing step.

9. A method for producing tofu coagulant according to claim 7, wherein interfacial tension of the food fat against distilled water is between 10 and 34 mN/m at room temperature.

10. A method for producing tofu coagulant according to claim 7, wherein the concentration of mineral salt solution is 2 M or more.

11. A method for producing tofu coagulant according to claim 7, wherein the mineral salt solution comprising at least any one of a magnesium chloride, calcium chloride, sodium chloride, potassium chloride, magnesium sulfate, magnesium chloride seawater crude.

12. A method for producing tofu coagulant according to claim 7, wherein the water phase and the oil phase ratio is between 1:0.2 and 1:3, preferably the ratio is between 1:0.4 and 1:1.5.

13. A method for producing tofu coagulant according to claim 7, wherein the food fat is a plant-derived ingredient and comprising: phospholipid is 0.1% or less, monoacylglycerol is 1% or less, triacylglycerol is 98% or less.

14. A method for producing tofu coagulant according to claim 7, wherein acid value of the food fat is 0.1 or higher, or free fatty acids of the food fat is 0.05% or more.
